(19) United States
(12) Patent Application Publication
(10) Pub. No.: US 2010/0259152 A1
(43) Pub. Date: Oct. 14, 2010

(54) DISCHARGE LAMP

(75) Inventors: Makoto Yasuda, Nagano (JP); Go Kobayashi, Nagano (JP); Sachio Shioya, Nagano (JP)

Correspondence Address: PATENTTM.US, P. O. BOX 82788, PORTLAND, OR, 97282-0788, US

(73) Assignee: ORC MANUFACTURING CO., LTD., Machida-shi, Tokyo (JP)

(21) Appl. No.: 12/747,323

(22) PCT Filed: Nov. 21, 2008
(86) PCT No.: PCT/JP2008/071217

§ 371 Date: Jun. 10, 2010

(30) Foreign Application Priority Data
Dec. 17, 2007 (JP) 2007-324201

(51) Int. Cl. H01J 61/04; H01J 61/30; H01J 61/16

(52) U.S. Cl. 313/113; 313/631

(57) ABSTRACT

The object of this invention is to prevent surface discharge even when a high voltage is applied in a dielectric-barrier discharge lamp or a capacitively coupled high frequency discharge lamp with no electrodes in a discharge space. Ribbon foil electrodes 3 are embedded in the wall of a quartz discharge vessel 1. The discharge vessel 1 is disposed such that the foil electrodes 3 face each other on both sides of the axis of the quartz discharge vessel 1. It may be disposed such that the foil electrodes 3 have a truncated V-shaped cross-section. The single tube quartz discharge vessel 1 is filled with discharge gas to form excimer molecules by dielectric barrier discharge or capacitively coupled high-frequency discharge.

### FIELD OF THE INVENTION

The present invention relates mainly to the dielectric barrier discharge lamp and the capacitively coupled high-frequency discharge lamp for industry use, for example, an excimer lamp and a low-pressure mercury lamp for UV source.

### BACKGROUND OF THE INVENTION

There is a xenon excimer lamp to emit UV ray of 172 nm wavelength as an example of the above-mentioned industrial UV source. Double tube structure is frequently used for excimer lamps. These lamps have emitting tube elongated along the longitudinal axis. An example of such a lamp is disclosed in the patent document 1 and so on. The excimer lamp filled with xenon gas is often used for dry cleaning of substrates of liquid crystal panels for example. The substrate under irradiation is moved at fixed speed on a conveyor in this case. The lamp is installed above the substrate perpendicular to conveyor flow. The whole substrate can be processed uniformly since the substrate is moved at fixed speed while the whole width of the substrate is irradiated at once. And also UV ray is often used for wafer surface reforming and so on in semiconductor manufacturing processes. Therefore, 172 nm UV ray from xenon excimer, 222 nm UV ray from excimer of krypton and chlorine, and 254 nm UV ray of mercury resonance are often used. Moreover, there is also devised a fluorescent lamp with electrodes arranged at the both sides of a discharge vessel of not double but a single tube. A heat-resistant layer such as glass bulb or ceramics covers this lamp in order to raise safety and also to prevent the surface discharge in operation. Some examples of the conventional technology relevant to it are given in the following.

The dielectric barrier discharge lamp of dual tube type as disclosed in the patent document 1 is constructed as one electrode is formed at the inner surface of the inner tube and another electrode is formed at the outer surface of the outer tube. When high frequency voltage of several kilo volts is applied between both electrodes, dielectric barrier discharge arises in the discharge space between the inner tube and the outer tube. As the high voltage of several kilo volts is applied to the electrodes, there is a possibility that surface discharge may occur between the electrodes along the electric discharge vessel surface. The surface discharge can be prevented by long enough distance between the end of the vessel and the end of the electrode or by adding the insulator to the ends of the discharge vessel. Tubular lamp of dual tube type as mentioned above is often used generally for the conventional excimer lamp.

The rare gas discharge lamp as disclosed in the patent document 2 is aimed to prevent surface discharge and accidental electric shock by ensuring the insulation of the electrodes on the outer wall. As shown in FIG. 5(a), in the tubular glass bulb with fluorescent film deposited on the inner wall, rare gas with main ingredient of xenon gas is filled. On the outer wall of the glass bulb, almost all over the glass bulb, a pair of ribbon electrodes is arranged. On the glass bulb including the ribbon electrodes, insulator coating film made of silicone resin or the like is disposed. Moreover, this insulator coating film is covered with a heat shrinkable insulator tube.

The rare gas discharge lamp as disclosed in the patent document 3 is aimed to prevent surface discharge and accidental electric shock by ensuring the insulation of the electrodes on the outer wall. As shown in FIG. 5(b), in the tubular glass bulb with fluorescent film deposited on the inner wall, rare gas with main ingredient of xenon gas is filled. On the outer wall of the glass bulb, a pair of ribbon electrodes is arranged. On the surface of the glass bulb, insulator coating film of silicone resin is formed. Moreover, this film is covered with a heat shrinkable polyester resin tube. Thus the ribbon electrodes are protected by double insulation.

The fluorescent lamp as disclosed in the patent document 4 is the lamp with raised safety to high voltage applied to the external electrodes. As shown in FIG. 5(c), illuminative layer is deposited on the inner surface of the glass bulb vessel in order to form apertures. The external electrodes of aluminum tapes are opposed each other along the axis on the outer surface of this vessel. A lead is connected at each end of external electrodes for connection to external circuit. The covering layer of glass bulb is formed on the outer surface of the vessel in order to cover the main part of the external electrode.

The fluorescent discharge tube as disclosed in the patent document 5 is the tube of prevented external discharge by the insulator film and also the tube of raised mechanical strength with auxiliary bulb. As shown in FIG. 5(d) pair of opposing external ribbon electrodes is extending along the axis on the outer cylindrical surface of glass bulb filled with rare gas inside. The insulator film covers all over the external surface of the cylinder. The insulator film is protected as an auxiliary bulb encloses the glass bulb and covers the insulator film. External electric discharge can be prevented because the dispersing carbon powder does not adhere to insulator film when this fluorescent discharge tube is installed in a facsimile.

The fluorescent lamp as disclosed in the patent document 6 is aimed to prevent the depositing humidity to lower the insulation resistance between the external electrodes on the surface of the glass bulb. As shown in FIG. 5(e), the fluorescent film is formed on the inner surface of the tubular glass bulb. A pair of external transparent electrodes is formed on the outer surface of the glass bulb. Discharge media is filled in the bulb. The insulator film of silicone resin is formed between the pair of the external electrodes on the outer surface of the glass bulb in order to prevent the insulation lowering of the humid glass bulb and to prevent short circuits between two external electrodes. The insulator layer may be formed not only between the external electrodes but also all over around the bulb. The insulation between the electrodes becomes perfect and also the lead can be firmly fixed to the electrode when the insulator layer is formed all around. The heat shrinkable tube of polyethylene may be put on the bulb for covering all around the bulb.

Patent document 1: JP3170952 B
Patent document 2: JP04-087249A
Patent document 3: JP04-112449A
Patent document 4: JPU05-090803A
Patent document 5: JP07-272691A
Patent document 6: JP09-092227A

### DISCLOSURE OF THE INVENTION

### Problem to be Resolved by the Invention

However, excimer radiation requires high gas pressure and especially high applied voltage. Mere insulator-covered electrode is proved completely unreliable. The reason is why dielectric breakdown may arise through very narrow gap between the discharge vessel and the covering layer, even though the covering glass layer is adhered to the electrodes by heating.

Temperature cannot be raised enough by heating in case of aluminum foil electrode because of low melting point of aluminum. Therefore, it is difficult to cover the electrodes along the form without gap. And also, if there is a difference in the thermal expansion coefficient between the discharge vessel and the covering layer, the heat history by blink of a lamp causes stress and a very little gap arises gradually in the interface. Then there arises a possibility of resulting in a breakdown. Because bubbles and gaps are arising in case of covering with melted glass by spraying, there is a possibility of carrying out a breakdown through these bubbles and gaps. For these reasons, sufficient high voltage cannot be applied to the conventional lamp of single tubular discharge vessel. Therefore, only the low radiation output lamp has been realized.

The object of this invention is to provide a reliable discharge lamp of external electrode type without any surface discharge under the high voltage enough to yield high radiation output.

### Means to Resolve the Problem

In order to resolve the above-mentioned problems, the discharge lamp in this invention is constituted as follows. The discharge lamp comprises a tubular quartz discharge vessel and foil electrodes. The tubular quartz discharge vessel is filled with discharge gas that forms excimer molecules by dielectric barrier discharge or capacitively coupled high-frequency discharge. The foil electrodes are embedded in the discharge vessel opposing in parallel along the axis in both sidewalls of the discharge vessel. The foil electrodes are embedded in symmetry along the cylindrical wall of the discharge vessel. Or the foil electrodes are embedded along the cylindrical wall of the discharge vessel with truncated V-shaped arc cross-section. Or the foil electrodes are embedded in symmetry with parallel two flat plates. Or the foil electrodes are embedded with the truncated flat V-shaped cross-section.

And also, the discharge lamp comprises a foil electrode and an external electrode. The foil electrode is embedded in the wall of the discharge vessel along the axis. The external electrode is arranged along the axis on the external cylindrical surface of the discharge vessel. The foil electrode is embedded along the cylindrical surface of the discharge vessel. Or flat foil electrode is embedded in the wall of the discharge vessel. The light reflector of metal plate or of multi-layer dielectric film is arranged in the exterior of the discharge vessel.

And also, a foil electrode and a mesh electrode are arranged. The foil electrode is embedded in the wall of the discharge vessel in the axis. The mesh electrode is embedded in the wall of the discharge vessel in the axis. Or the mesh electrode is laid in the axis on the external cylindrical surface of the discharge vessel. The foil electrode is embedded along the cylindrical surface of the discharge vessel. Or flat foil electrode is embedded in the wall of the discharge vessel. Main ingredient of the foil electrode is molybdenum, tantalum or tungsten.

And also, the feeder to the electrode is arranged opposite to each other along the axis. The discharge gas is the rare gas or the gas mixture of rare gas and the halogen gas. And also, an optical outlet is arranged at one axial end of the discharge vessel.

### ADVANTAGES OF THE INVENTION

The lamp becomes highly reliable as the surface discharge can be prevented firmly in consequence of above constitution. And also, the irradiation of the lamp becomes intensive as the applicable voltage can be raised high enough. And also, the lamp becomes small, thin and inexpensive as the lamp can be made with a single tube.

### THE BEST FORM FOR THE EMBODIMENT OF THIS INVENTION

Hereinafter, the best embodiments of this invention are explained referring to the FIGS. 1 through 4.

### Embodiment 1

The first embodiment of this invention is the discharge lamp with foil electrodes embedded oppositely in parallel along the axis in both sidewalls of the discharge vessel.

FIG. 1 shows the conceptual diagram of the discharge lamp of the first embodiment of this invention. FIG. 1(a) is the cross section along the axis of the discharge lamp. FIG. 1(b) is the cross section along the radius of the discharge lamp. FIG. 1(c) is the cross section along the radius of the discharge lamp with reflector. FIG. 1(d) is the cross section along the radius of the discharge lamp with electrodes of truncated V-shaped arc cross-section. FIG. 1(e) is the cross section along the axis of the discharge lamp with optical outlet window along the axis. FIGS. 1 (f) and (g) are the cross section along the radius to show the manufacturing process of the discharge lamp.

In FIG. 1, the quartz discharge vessel 1 is a single tube of quartz. It is also called simply a discharge vessel. It may be elliptical or polygonal as tetragonal or hexagonal and so on. The discharge vessel does not have to be quartz. Although a tubular quartz discharge vessel is explained as a typical example, this vessel means to include the vessels of same characteristic other materials. Hard glass vessel can be used as discharge vessel for the dielectric barrier discharge lamp to radiate the light of 308 nm wavelength filled with gas mixture of xenon and chlorine. The protective coating of alumina film, titania film or magnesia film is properly formed on the discharge vessel surface in order to prevent the discharge vessel glass from getting fragile and from reacting chemically with the filled gas. The film of magnesium fluoride and so on is formed in case that the filled gas contains halogen.

The discharge space 2 is the space in the discharge vessel where discharge occurs. There are no electrodes in the discharge space. Xenon gas or the gas mixture of krypton gas and chlorine gas is filled in the discharge space. The gas filled in the discharge space may be the gas to generate excimer light. Or, it may be the gas to generate the UV ray of 254 nm or 185 nm wavelength of mercury characteristic UV ray. Other suitable enclosure gas can be chosen for obtaining the light of corresponding wavelength. Here is explained as an example about the discharge gases to form excimer molecules. However, those gases mean to include other discharge gases to emit light similarly.

The foil electrodes 3 are the ribbon foil electrodes. The foil electrodes 3 are embedded in the top and the bottom of the wall of the discharge vessel 1 face to face symmetrically with respect to the axis. The foil electrodes 3 are made of molybdenum foil. One end of molybdenum foil is taken out to the exterior of the discharge vessel 1. The other end of the foil electrode 3 at termination is completely embedded in the discharge vessel wall. The foil electrode 3 extends outside for the electric connection with the exterior circuit. The extraction position of each end is in the opposite side of the lamp. A molybdenum stick may be used for connecting the foil electrode 3 electrically to outside circuit. The similar materials of the same quality other than molybdenum foil are sufficient as the foil electrode 3. The reflector 4 is a component to reflect light. The reflector 4 may be unnecessary depending upon the purpose of the discharge lamp. The outlet 6 is a window for taking out light in the axial direction.

The function and the operation of the discharge lamp in the first embodiment of this invention constituted as above are explained. First, the outline of the function of the discharge lamp is explained referring to FIGS. 1(a) and 1(b). The foil electrodes 3 are embedded along the axis in both sidewalls of the quartz tubular discharge vessel face to face in parallel. The foil electrodes 3 are symmetrically embedded along the cylindrical surface of the discharge vessel 1. The main ingredient of the foil electrode 3 is molybdenum, tantalum or tungsten. Feeder to each foil electrode 3 is arranged at each end of the longitudinal axis of the lamp. The discharge vessel 1 is filled with the discharge gas to form excimer molecules by dielectric barrier discharge or capacitively coupled high-frequency discharge. The discharge gas is rare gas or the gas mixture of rare gas and halogen gas.

When high frequency voltage is applied between the foil electrodes 3, dielectric barrier discharge occurs. The xenon excimer light of 172 nm wavelength is generated then and it can be taken out of the space between the foil electrodes 3. The excimer light of wavelength 222 nm can be taken out in case of krypton and chlorine discharge gas. Or, high frequency discharge occurs in low-pressure mercury gas and the mercury UV ray of wavelength 254 nm or 185 nm can be obtained when mercury and argon gas are filled in the lamp. In this case, the coldest region must be controlled to keep at adequate temperature in order to maintain the mercury vapor pressure of lighting at optimal value. Wide range can be irradiated using these discharge lamps.

Next, the discharge lamp with a light reflector is explained referring to FIG. 1(c). The reflector 7 is arranged on the outer upper surface of the discharge vessel 1. The reflector 7 is formed by vapor deposition and it consists of multilayer film of silicon oxide and titanium oxide. Or the reflector 7 may be a simple metal plate. The extraction direction of light is perpendicular to the opposing foil electrodes 3 in case of the composition shown in FIG. 1(b). The reflector 7 reflects the upward light downward and then the downward light gets brightened.

Next, the discharge lamp with foil electrodes of truncated V-shaped cross-section is explained referring to FIG. 1(d). The foil electrodes 3 are embedded in the discharge vessel 1 to form truncated V-shaped cross-section along the cylindrical surface of the discharge vessel 1. The foil electrodes 3 are located above the longitudinal axis of the discharge vessel 1. Therefore, the distance between the foil electrodes 3 is narrow at upside and wide at downside. The discharge occurs above the center of the vessel because the discharge region is between the opposing electrodes. The foil electrodes 3 scarcely interrupt the light since the foil electrodes 3 are located in the upper part. The discharge-generated light can be taken out efficiently downward and strong radiation output can be obtained.

Next, the discharge lamp for emitting the light along the axis is explained referring to FIG. 1(e). The light outlet window is furnished at one axial end of the discharge vessel 1. One end of the discharge vessel 1 becomes an output window 6. The light emitted between the foil electrodes 3 is taken out along the axis. Therefore, the light generated in a long discharge region is overlapped along the axis and becomes strong light. And also, the light can be taken out without trapping by the foil electrodes 3.

Next, the manufacturing method of the discharge lamp is explained referring to FIGS. 1(f) and 1(g). As shown in FIG. 1(f), two quartz tubes of different diameter are prepared for manufacture of the discharge vessel 1. A thin quartz tube is inserted into a thick quartz tube to form coaxial tubes. The molybdenum foil is inserted between the tubes. The tubes are heated at the outside with keeping vacuum in the gap between the thick tube and the thin tube. The thick tube is deformed to stick to the thin tube. When the tubes are heated further, the tubes are melted to adhere completely except the molybdenum foil portion. Two tubes are unified. As shown in FIG. 1(g), the discharge vessel 1 is made up. Molybdenum foil becomes embedded in the wall of the discharge vessel 1. The surface discharge as undesirable discharges at the outside of the discharge space 2 can be prevented.

As described above, in the first embodiment of this invention, the foil electrodes are constituted as embedded oppositely in parallel along the axis in both sidewalls of the discharge vessel, therefore the surface discharge can be prevented accurately and the reliability of the lamp can be raised. And also, as the applicable voltage can be raised high enough, the output of the lamp can be raised. And also, as the lamp can be made with a single tube, the compact thin low-cost lamp can be realized.

### Embodiment 2

The second embodiment of this invention is the discharge lamp that a foil electrode is embedded along the axis in the wall of the discharge vessel and an external electrode is arranged along the axis on the outer cylindrical surface of the discharge vessel.

FIG. 2 is a conceptual diagram of the discharge lamp of the second embodiment of this invention. FIG. 2(a) is a cross section along the axis of the discharge lamp. FIG. 2(b) is a cross section along the radius of the discharge lamp. FIG. 2(c) is a cross section along the radius of the discharge lamp with a reflector. FIG. 2(d) is a cross section along the radius of the discharge lamp with the electrodes of truncated V-shaped cross section. FIG. 2(e) is a cross section along the radius of the discharge lamp with an optical outlet along the axis. FIGS. 2(f) and 2(g) are cross sections along the radius to show the manufacturing process of the discharge lamp. In FIG. 2, the external electrode 7 is an electrode arranged along the axis on the outer cylindrical surface of the discharge vessel. Other basic constitutions are the same as the first embodiment. The explanation about the same part as the first embodiment is omitted.

The function and the operation of the discharge lamp in the second embodiment of this invention constituted as above are explained. First, the outline of the function of the discharge lamp is explained referring to FIGS. 2(a) and 2(b). A foil electrode 3 is embedded along the axis in the wall of the quartz tubular discharge vessel 1. An external electrode 7 is arranged along the axis on the external cylindrical surface of the discharge vessel 1.

Next, a variant of the discharge lamp is explained referring to FIGS. 2(c) to 2(e). FIG. 2(c) shows a discharge lamp with a reflector. A reflector 7 is furnished on the external upper surface of the discharge vessel 1. FIG. 2(d) shows a discharge lamp with electrodes of truncated V-shaped cross section. A foil electrode 3 is embedded in the discharge vessel 1 and an external electrode 7 is furnished along the cylindrical surface of the discharge vessel 1 as to form a truncated V-shaped cross section. FIG. 2(e) shows a discharge lamp to take out light in the axial direction. An optical outlet is furnished at one axial end of the discharge vessel 1.

Next, the manufacturing process of the discharge lamp is explained referring to FIGS. 2(f) and 2(g). Two quartz tubes of different diameter are prepared for manufacture of the discharge vessel 1. As shown in FIG. 2(f), a thin quartz tube is inserted into a thick quartz tube to form coaxial tubes. The molybdenum foil is inserted between the tubes. The tubes are heated at the outside with keeping vacuum in the gap between the thick tube and the thin tube. The thick tube is deformed to stick to the thin tube. When the tubes are heated further, the tubes are melted to adhere completely except the molybdenum foil portion. Two tubes are unified. As shown in FIG. 2(g), the discharge vessel 1 is made up. Molybdenum foil becomes embedded in the wall of the discharge vessel 1. The surface discharge as undesirable discharges outside of the discharge space 2 can be prevented.

As described above, in the second embodiment of this invention, a foil electrode is as embedded along the axis in the wall of the discharge vessel and an external electrode is arranged along the axis on the outer cylindrical surface of the discharge vessel, therefore the surface discharge can be prevented accurately and the reliability of the lamp can be raised. And also, as the applied voltage can be raised high enough, the output of the lamp can be raised. And also, as the lamp can be made with a single tube, the compact thin low-cost lamp can be realized.

### Embodiment 3

The third embodiment of this invention is the discharge lamp that planar foil electrodes are embedded oppositely in parallel along the axis in both sidewalls of the discharge vessel.

FIG. 3 is a conceptual diagram of the discharge lamp of the third embodiment of this invention. FIG. 3(a) is a cross section along the axis of the discharge lamp. FIG. 3(b) is a cross section along the radius of the discharge lamp. FIG. 3(c) is a cross section along the radius of the discharge lamp with a reflector. FIG. 3(d) is a cross section along the radius of the discharge lamp with the electrodes of truncated V-shaped cross section. FIG. 3(e) is a cross section along the radius of the discharge lamp with an optical outlet window along the axis. Other basic constitutions are the same as the first embodiment. The explanation about the same part as the first embodiment is omitted.

The function and operation of the discharge lamp in the third embodiment of this invention constituted as above are explained. First, the outline of the function of the discharge lamp is explained referring to FIGS. 3(a) and 3(b). A foil electrode 3 is embedded along the axis in the wall of the quartz tubular discharge vessel 1. The foil electrodes 3 are planar and embedded symmetrically. The thickness between the metal foil and the inner surface of the lamp is made thin. The manufacturing process in order to thin the thickness b is as follows. When two tubes of different diameter are formed coaxial tubes and the molybdenum foil is inserted between the tubes for manufacturing the vessel, the both side surfaces of the inner tube are scraped in flat previously. The scraped flat surfaces prevent the foils from moving and the metal foils are adhered to the desired position of the discharge vessel. And also, as the wall side is scraped in flat, the strength of the inner tube is weakened. It is better to increase thickness a of the tube portions other than metallic foil. When thickness b is small, partial voltage out of the total voltage applied to the electrodes, the voltage applied to the discharge space becomes high. For this reason, applied voltage for obtaining the same optical power can be decreased.

Next, the discharge lamp with a reflector is explained referring to FIG. 3(c). A reflector 7 is furnished on the external upper surface of the discharge vessel 1. The reflector 7 is formed by vapor deposition and consists of multilayer film of silicon oxide and titanium oxide. Or the reflector 7 may be a simple metal plate. The light-extracting direction is perpendicular to the opposing foil electrodes 3 in case of the composition shown in FIG. 1(b). The reflector 7 reflects the upward light downward and then the downward light is brightened.

Next, an example of discharge lamp using planar foil electrodes with truncated V-shaped cross section is explained referring to FIG. 3(d). The foil electrodes 3 are embedded in the discharge vessel 1 to form truncated V-shaped cross-section. The foil electrode 3 is located above the longitudinal axis of the discharge vessel 1. Therefore, the distance between the foil electrodes 3 is narrow at the upside and wide at the downside. The discharge occurs above the center of the vessel because the discharge region is between the opposing electrodes. The foil electrodes 3 scarcely interrupt the light since the foil electrodes 3 are located in the upper part. The discharge-generated light can be taken out efficiently downward and strong radiation output can be obtained. The reflector 4 is furnished if necessary.

Next, the discharge lamp for emitting the light along the axis is explained referring to FIG. 3(e). The light outlet is furnished at one axial end of the discharge vessel 1. One end of the discharge vessel 1 becomes an output window 6. The light emitted between the foil electrodes 3 is taken out along the axis. Therefore, the light generated in a long discharge region is overlapped along the axis and becomes strong light. And also, the light can be taken out without trapping by the foil electrodes 3.

As described above, in the third embodiment of this invention, the planar foil electrodes are constituted as embedded oppositely in parallel along the axis in both sidewalls of the discharge vessel, therefore the surface discharge can be prevented accurately and the reliability of the lamp can be raised. And also, as the applied voltage can be raised high enough, the output of the lamp can be raised. And also, as the lamp can be made with a single tube, the compact thin low-cost lamp can be realized.

### Embodiment 4

The fourth embodiment of this invention is the discharge lamp that foil electrode is embedded along the axis in the wall of the discharge vessel and the mesh electrode is arranged along the axis on the outer cylindrical surface of the discharge vessel.

FIG. 4 is a conceptual diagram of the discharge lamp of the fourth embodiment of this invention. FIG. 4(a) is a cross section along the radius of the discharge lamp with mesh electrode on the outer surface of the discharge vessel. FIG. 4(b) is a cross section along the radius of the discharge lamp with a planar foil electrode and a mesh electrode in the discharge vessel wall. FIG. 4(c) is a cross section along the radius of the discharge lamp with a planar foil electrode in the discharge vessel wall and a mesh electrode on the outer surface of the discharge vessel wall. FIG. 4(d) is an example of planar lamp. In FIG. 4, a mesh electrode 5 is a reticular electrode. Other basic constitutions are the same as the first embodiment. The explanation about the same part as the first embodiment is omitted.

The function and the operation of the discharge lamp in the fourth embodiment of this invention constituted as above are explained. First, the outline of the function of the discharge lamp is explained referring to FIG. 4(a). A foil electrode 3 is embedded in the wall of the quartz tubular discharge vessel 1. In this example, a foil electrode 3 of only one hand is embedded in the wall of the discharge vessel 1. The metallic mesh electrode 5 is the pair electrode of the foil electrode 3. Reticular conductor may be directly printed on the discharge vessel 1 for forming mesh electrode 5. The mesh electrode 5 is usually used as the ground electrode. The high frequency voltage is applied to the foil electrode 3. In case of the discharge lamp with two foil electrodes 3, because of the light trap by the foil electrodes, some part of light cannot be taken out of the lamp. In case of the discharge lamp with mesh electrode 5, because of much decrease of the light trap, light amount of the discharge lamp increases and the emission efficiency is raised much.

Next, a variant of the discharge lamp is explained referring to FIG. 4(b). A planar foil electrode 3 is embedded in the wall of the tubular discharge vessel 1. A mesh electrode 5 is embedded in the wall of the discharge vessel 1. As the partial voltage on the discharge space out of the total external voltage to the electrodes becomes high, applied voltage for obtaining the same optical power can be decreased.

Next, another variant of the discharge lamp is explained referring to FIG. 4(c). A planar foil electrode 3 is embedded in the wall of the tubular discharge vessel 1. A pair metallic mesh electrode 5 to the foil electrode 3 is furnished on the outer surface of the discharge vessel 1. As the partial voltage on the discharge space out of the total external voltage to the electrodes becomes high, applied voltage for obtaining the same optical power can be decreased. FIG. 4(d) shows an example of a planar lamp.

As described above, in the fourth embodiment of this invention, as a foil electrode is embedded along the axis in the wall of the discharge vessel and a mesh electrode is furnished along the axis on the outer cylindrical surface of the discharge vessel, the surface discharge can be prevented accurately and the reliability of the lamp can be raised. And also, as the applicable voltage can be raised high enough, the output of the lamp can be raised. And also, as the lamp can be made with a single tube, the compact thin low-cost lamp can be realized.

### INDUSTRIAL APPLICABILITY

The discharge lamp of this invention is most suitable for the industrial UV source.

### BRIEF DESCRIPTION OF THE DRAWINGS

FIG. 1 shows a conceptual diagram of the discharge lamp of the first embodiment of this invention.

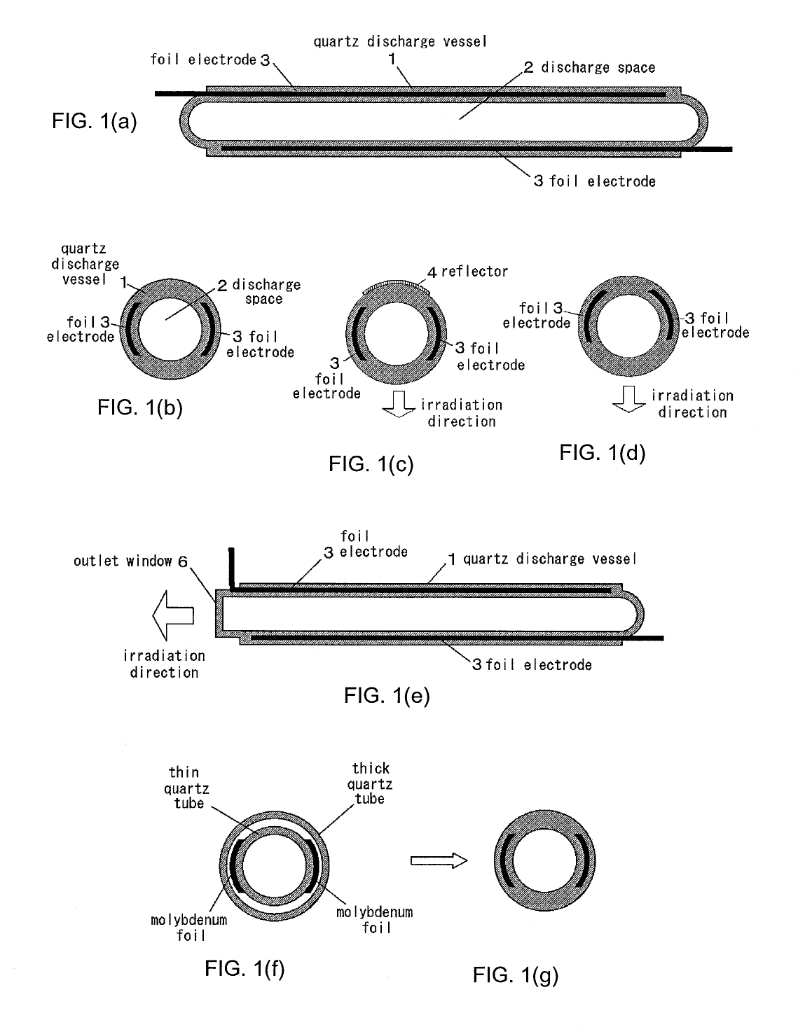

FIG. 2 shows a conceptual diagram of the discharge lamp of the second embodiment of this invention.

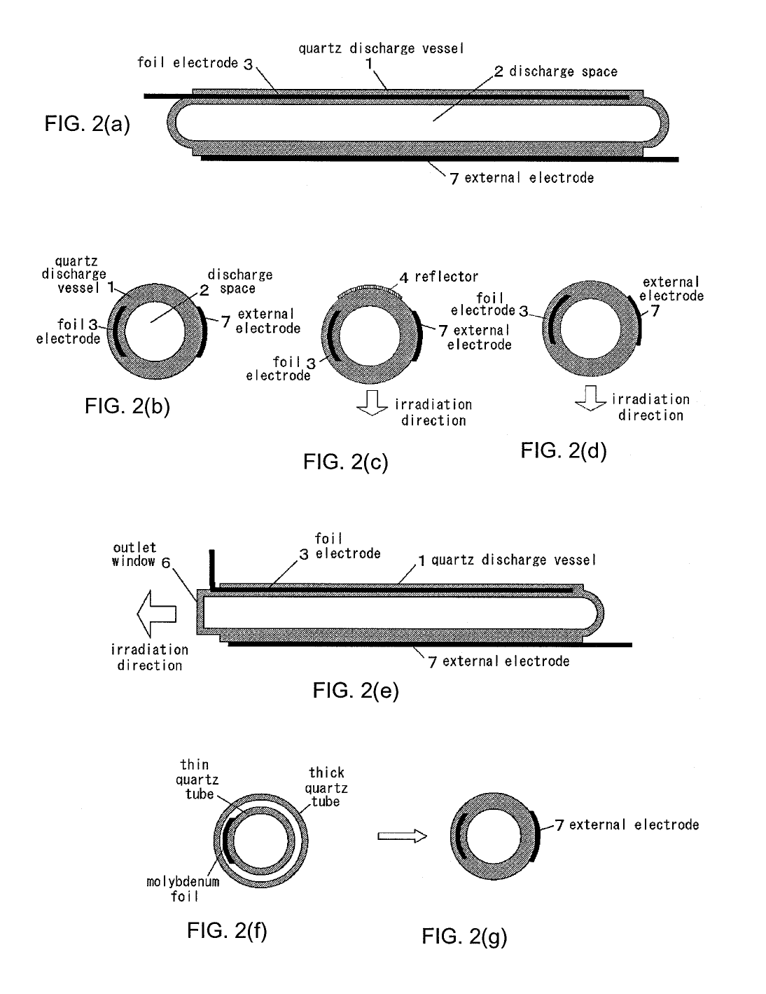

FIG. 3 shows a conceptual diagram of the discharge lamp of the third embodiment of this invention.

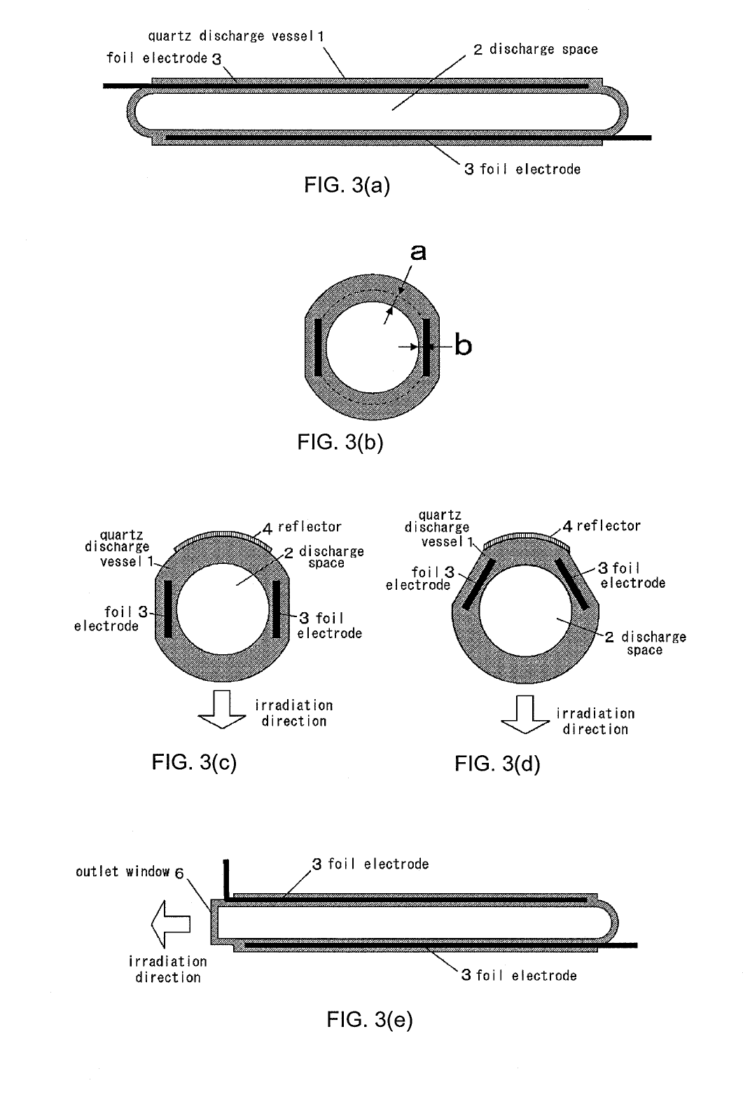

FIG. 4 shows a conceptual diagram of the discharge lamp of the fourth embodiment of this invention.

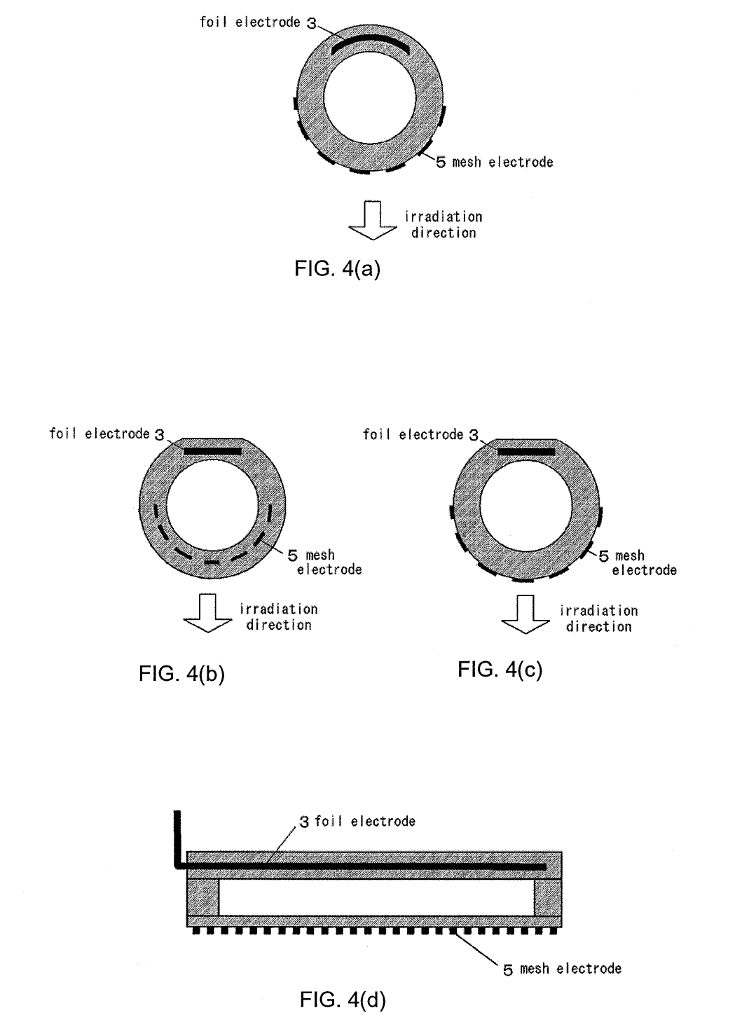

FIG. 5 shows conceptual diagrams of the conventional discharge lamps.

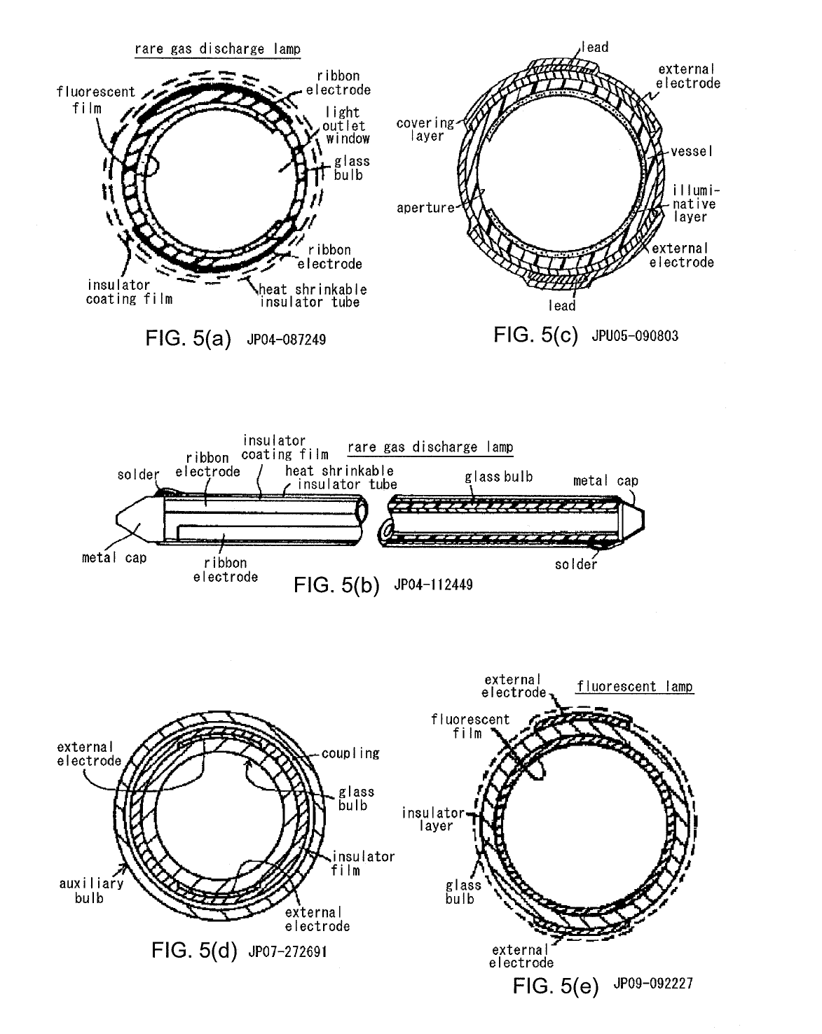

### REFERENCE SYMBOLS

1: quartz discharge vessel
2: discharge space
3: foil electrode
4: reflector
5: mesh electrode
6: outlet window
7: external electrode

1. A discharge lamp characterized by that discharge gas is enclosed in the discharge vessel, electrodes are arranged on both counter sides of the discharge vessel, and at least one electrode is embedded in the wall of the discharge vessel.

2. A discharge lamp as described in claim 1, wherein excimer molecules are formed in the discharge vessel by the dielectric barrier discharge or capacitively coupled high-frequency discharge.

3. A discharge lamp as described in claim 1, wherein at least a part of the discharge vessel is quartz.

4. A discharge lamp as described in claim 1, wherein one electrode, among the oppositely-arranged electrodes, that is installed in the inside of the tube wall of the discharge vessel is a foil of simple substance of either one of molybdenum, tantalum or tungsten, or a foil whose main ingredient is either one of molybdenum, tantalum or tungsten.

5. A discharge lamp as described in claim 1, wherein both of the oppositely-arranged electrodes embedded in the tubular vessel wall are elongated along the axis and their power-feeder lines are arranged oppositely each other.

6. A discharge lamp as described in claim 1, wherein the discharge gas is the rare gas or the mixture of rare gas and the halogen gas.

7. A discharge lamp as described in claim 1, wherein a light reflector is arranged at one-side optical window out of two windows of the discharge space along the direction perpendicular to the direction along oppositely arranged two electrodes.

8. A discharge lamp as described in claim 7, wherein the light reflector is a metal plate or deposit plate of multilayer dielectric film on a substrate arranged in the exterior of the discharge vessel.

9. A discharge lamp as described in claim 7, wherein the light reflector is the deposit film of metal or the multilayer dielectrics on the outer surface of the discharge vessel.

10. A discharge lamp as described in claim 1, wherein one electrode of the oppositely arranged electrodes is embedded inside of the wall of the discharge vessel and another electrode is arranged at the exterior of the vessel.

11. A discharge lamp as described in claim 10, wherein the electrode arranged at the exterior of the vessel is a meshed metal.

12. A discharge lamp as described in claim 2, wherein at least a part of the discharge vessel is quartz.

13. A discharge lamp as described in claim 2, wherein one electrode, among the oppositely-arranged electrodes, that is installed in the inside of the tube wall of the discharge vessel is a foil of simple substance of either one of molybdenum, tantalum or tungsten, or a foil whose main ingredient is either one of molybdenum, tantalum or tungsten.

14. A discharge lamp as described in claim 3, wherein one electrode, among the oppositely-arranged electrodes, that is installed in the inside of the tube wall of the discharge vessel is a foil of simple substance of either one of molybdenum, tantalum or tungsten, or a foil whose main ingredient is either one of molybdenum, tantalum or tungsten.

15. A discharge lamp as described in claim 2, wherein both of the oppositely-arranged electrodes embedded in the tubular vessel wall are elongated along the axis and their power-feeder lines are arranged oppositely each other.

16. A discharge lamp as described in claim 3, wherein both of the oppositely-arranged electrodes embedded in the tubular vessel wall are elongated along the axis and their power-feeder lines are arranged oppositely each other.

17. A discharge lamp as described in claim 4, wherein both of the oppositely-arranged electrodes embedded in the tubular vessel wall are elongated along the axis and their power-feeder lines are arranged oppositely each other.

18. A discharge lamp as described in claim 2, wherein the discharge gas is the rare gas or the mixture of rare gas and the halogen gas.

19. A discharge lamp as described in claim 3, wherein the discharge gas is the rare gas or the mixture of rare gas and the halogen gas.

20. A discharge lamp as described in claim 4, wherein the discharge gas is the rare gas or the mixture of rare gas and the halogen gas.
